(19) United States
(12) Patent Application Publication
(10) Pub. No.: US 2016/0013821 A1
(43) Pub. Date: Jan. 14, 2016

(54) APPARATUS AND METHOD FOR FAST LOCAL OSCILLATOR RE-TUNE FOR RESIDUAL SIDE BAND REDUCTION

(71) Applicant: QUALCOMM Incorporated, San Diego, CA (US)

(72) Inventors: Jing Sun, San Diego, CA (US); Amit Mahajan, San Diego, CA (US); Sai Kwok, Escondido, CA (US); Rashid Ahmed Akbar Attar, San Diego, CA (US)

(21) Appl. No.: 14/865,737

(22) Filed: Sep. 25, 2015

Related U.S. Application Data
(62) Division of application No. 14/026,877, filed on Sep. 13, 2013.

(51) Int. Cl. H04B 1/04

(52) U.S. Cl. CPC H04B 1/0475

(57) ABSTRACT

Various aspects of the present disclosure are directed to apparatuses and methods that can mitigate the undesirable effects of residual side band (RSB) signal by actively re-tuning the local oscillator of a transmitter to be at or near the center frequency of the carrier. Other aspects, embodiments, and features are also claimed and described.

### PRIORITY CLAIM

This application is a divisional application of prior patent application Ser. No. 14/026,877, filed in the United States Patent and Trademark Office on 13 Sep. 2013, the entire content of which is incorporated herein by reference.

### TECHNICAL FIELD

The technology discussed below relates generally to wireless communications, and more specifically, to apparatus and methods for reducing residual side band in wireless communications.

### BACKGROUND

In basic signal processing for wireless communications, information is transmitted by combining a relatively high frequency carrier wave and a modulating signal. The modulating signal can be referred to as the baseband signal (e.g., the lowest frequencies, near to zero Hertz). This is generally referred to as direct-conversion. The modulating signal generally represents the data to be transmitted, is said to be up-converted to the carrier frequency. In some modulation schemes, the modulating signal includes two orthogonal components: an in-phase component and a quadrature component. These components are typically referred to as the I and Q components, and are orthogonal by being out of phase by 90 degrees.

Residual side band (RSB) is one challenge for direct-conversion transceiver architectures. RSB is a known radio frequency (RF) issue in an up-convertor (part of a typical transmitter), and RSB may result when the modulating signal is at the baseband. In some cases, the amplitudes of the I and Q components of the modulating signal may not be equal, and/or the difference in phase between the I and Q components may not be precisely 90 degrees. In this scenario, when combined with the carrier signal, a spurious signal is generated at the mirror image location of the signal in the frequency domain. This spurious signal is the RSB signal. That is, the resulting modulated signal has two components, one at each side of the center of the carrier frequency.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various aspects of the present disclosure are directed to apparatuses and methods that can mitigate the undesirable effects of residual side band (RSB) signal by actively re-tuning the local oscillator of a transmitter to be at or near the center frequency of the carrier.

An aspect of the present disclosure provides a method of wireless communication operable at a wireless device configured for simultaneous transmission utilizing different radio access technologies (RATs). According to the method, a local oscillator of the wireless device is tuned to a tuning frequency between a first frequency corresponding to a first RAT and a second frequency corresponding to a second RAT. The wireless device simultaneously transmits a first reverse link transmission utilizing the first RAT and a second reverse link transmission utilizing the second RAT, and tunes the local oscillator to the first frequency and transmits a third reverse link transmission utilizing the first RAT.

Another aspect of the present disclosure provides a method of wireless communication operable at a wireless device configured for transmission utilizing a Long Term Evolution (LTE) network. According to the method, the wireless device transmits an uplink signal including a plurality of symbols utilizing a subset of a plurality of subcarriers, and actively tune a local oscillator to a frequency corresponding to a center frequency of the subset currently allocated to the uplink signal.

Another aspect of the present disclosure provides an apparatus configured for simultaneous transmission utilizing different radio access technologies (RATs). The apparatus includes means for tuning a local oscillator of the apparatus to a tuning frequency between a first frequency corresponding to a first RAT and a second frequency corresponding to a second RAT; means for simultaneously transmitting a first reverse link transmission utilizing the first RAT and a second reverse link transmission utilizing the second RAT; and means for tuning the local oscillator to the first frequency and transmitting a third reverse link transmission utilizing the first RAT.

Another aspect of the present disclosure provides an apparatus configured for transmission utilizing a Long Term Evolution (LTE) network. The apparatus includes: means for transmitting an uplink signal including a plurality of symbols utilizing a subset of a plurality of subcarriers, and means for actively tuning a local oscillator of the apparatus to a frequency corresponding to a center frequency of the subset currently allocated to the uplink signal.

Another aspect of the present disclosure provides an apparatus configured for simultaneous transmission utilizing different radio access technologies (RATs). The apparatus includes a processor, a communications interface operatively coupled to the processor, and a memory operatively coupled to the processor. The processor is configured to: tune a local oscillator of the apparatus to a tuning frequency between a first frequency corresponding to a first RAT and a second frequency corresponding to a second RAT; simultaneously transmit a first reverse link transmission utilizing the first RAT and a second reverse link transmission utilizing the second RAT; and tune the local oscillator to the first frequency and transmit a third reverse link transmission utilizing the first RAT.

Another aspect of the present disclosure provides an apparatus configured for transmission utilizing a Long Term Evolution (LTE) network. The apparatus includes a processor, a communications interface operatively coupled to the processor, and a memory operatively coupled to the processor. The processor is configured to: transmit an uplink signal including a plurality of symbols utilizing a subset of a plurality of subcarriers; and actively tune a local oscillator of the apparatus to a frequency corresponding to a center frequency of the subset currently allocated to the uplink signal.

Another aspect of the present disclosure provides a computer program product for simultaneous transmission utilizing different radio access technologies (RATs). The computer program product includes a computer-readable storage medium including code for: tuning a local oscillator of a transmitter to a tuning frequency between a first frequency corresponding to a first RAT and a second frequency corresponding to a second RAT; simultaneously transmitting a first reverse link transmission utilizing the first RAT and a second reverse link transmission utilizing the second RAT; and tuning the local oscillator to the first frequency and transmitting a third reverse link transmission utilizing the first RAT.

Another aspect of the present disclosure provides a computer program product configured for transmission utilizing a Long Term Evolution (LTE) network. The computer program product includes a computer-readable storage medium including code for: transmitting an uplink signal including a plurality of symbols utilizing a subset of a plurality of subcarriers; and actively tuning a local oscillator of a transmitter to a frequency corresponding to a center frequency of the subset currently allocated to the uplink signal.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a conceptual diagram illustrating the frequency spectrum of an output signal from a modulator.

FIG. 2 is a diagram illustrating the output signals and residual side band of two channels.

FIG. 3 is a block diagram illustrating select components of a wireless communication system according to some embodiments.

FIG. 4 is a block diagram illustrating select components of a wireless device according to some embodiments.

FIG. 5 is a block diagram illustrating select components of a modulating circuit according to some embodiments.

FIG. 6 is a flow chart illustrating a process operable at a dual radio access technology wireless device for performing fast local oscillator (LO) tuning in accordance with some embodiments.

FIG. 7 is a flow chart illustrating a process operable at a long term evolution (LTE) wireless device for performing fast LO tuning in accordance with some embodiments.

FIG. 8 is a diagram illustrating an example of an uplink frame structure in LTE.

FIG. 9 is a diagram conceptually illustrating subcarriers available for an LTE wireless device to transmit an uplink transmission.

FIG. 10 is a flow chart illustrating a method operable at a wireless device for simultaneous transmission utilizing two different RATs in accordance with some embodiments.

FIG. 11 is a flow chart illustrating a method operable at a wireless device configured for transmission utilizing an LTE network in accordance with some embodiments.

FIG. 12 is a functional block diagram of a processing circuit and a computer-readable storage medium configured to reduce residual side band at a wireless device in accordance with some embodiments.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

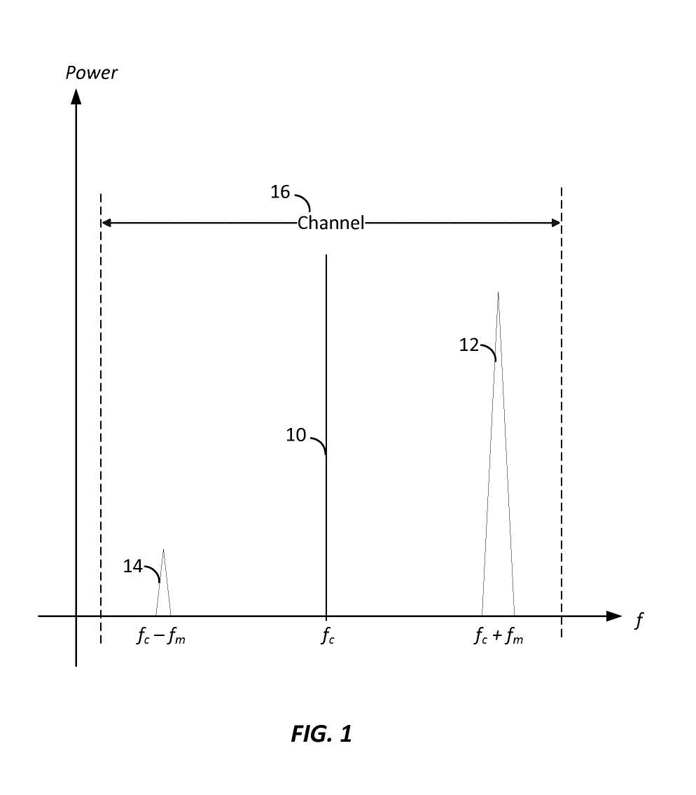

In a typical wireless transmitter, referring to FIG. 1, utilizing only a single radio technology, a single modulating signal fₘ is combined (“mixed”) with a single RF carrier signal f_{c} 10 (e.g., a frequency of a local oscillator LO). As illustrated, there will be one output signal 12 at the carrier frequency plus the frequency of the modulating signal, and an RSB mirror-image signal 14 of the signal at the carrier frequency minus the frequency of the modulating signal. When the modulated signal fₘ is not offset by a great amount from the frequency of the local oscillator (LO) (e.g., f_{c}), the RSB falls within the same channel 16 allocated for the intended signal 12 for transmission. However, this spurious RSB signal 14 is typically much lower in amplitude (power) than that of the intended transmission signal 12 (e.g., 24 dB or more lower than the intended signal), and generally does not pose a significant performance issue in a homogeneous deployment of base stations where all base stations have approximately equal transmit power, and have about the equal distance between one another. While the RSB signal 14 may slightly degrade the waveform quality of the intended signal 12, the degradation is generally within acceptable levels in a homogeneous network.

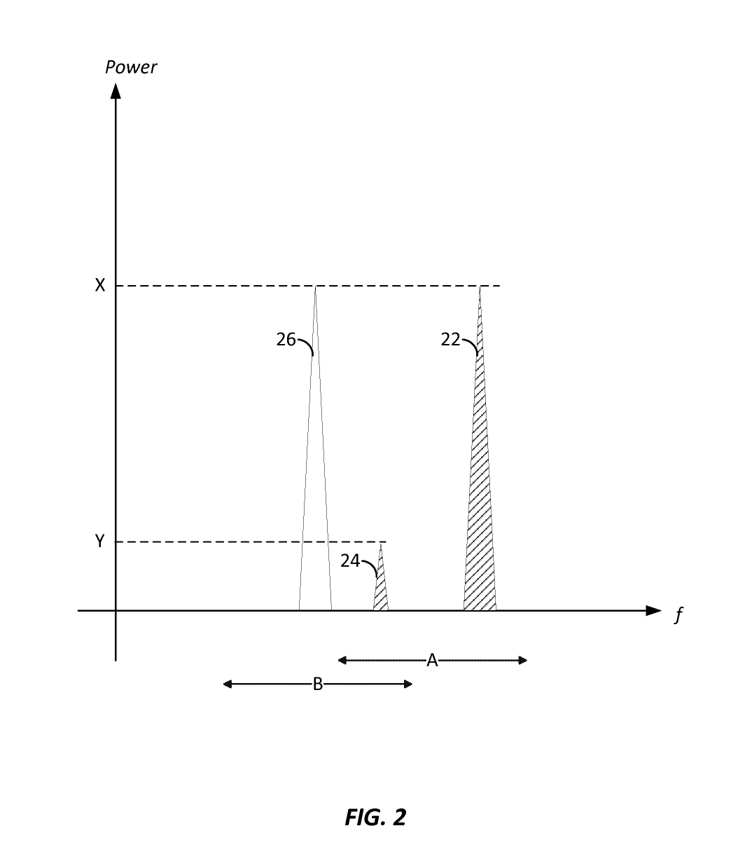

As an example, referring to FIG. 2, it is assumed that an RSB 24 is generated by a wireless device A, which transmits the intended signal 22 at a power level X. The resulting RSB signal 24 may be transmitted at a power level Y (where Y is much lower than X, e.g., 24 dB or more). The RSB signal 24 may fall on the same channel A allocated for the intended signal 22. A wireless device B may also use the portion of the channel A where the RSB signal 24 falls. For example, in an Orthogonal Frequency-Division Multiple Access (OFDMA) system such as an LTE network, adjacent channels or subcarriers may be partially overlapped. The intended transmitting signal 26 for a wireless device B may also be at the power level X. In this example, comparatively, the RSB signal 24 of the wireless device A will be far less powerful than the intended signal 26 from the wireless device B, and thus, there will generally be no performance issue caused by the RSB signal 24.

Aspects of the present disclosure provide methods and apparatuses for mitigating the undesirable effects of the RSB signal. The various concepts presented throughout this disclosure may be implemented across a broad variety of telecommunication systems, network architectures, and communication standards. Certain aspects of the disclosure are described below for CDMA (e.g., CDMA 2000) and 3^{rd} Generation Partnership Project 2 (3GPP2) 1× protocols and systems, and related terminology may be found in much of the following description. However, those of ordinary skill in the art will recognize that one or more aspects of the present disclosure may be employed and included in one or more other wireless communication protocols and systems such as Long Term Evolution (LTE).

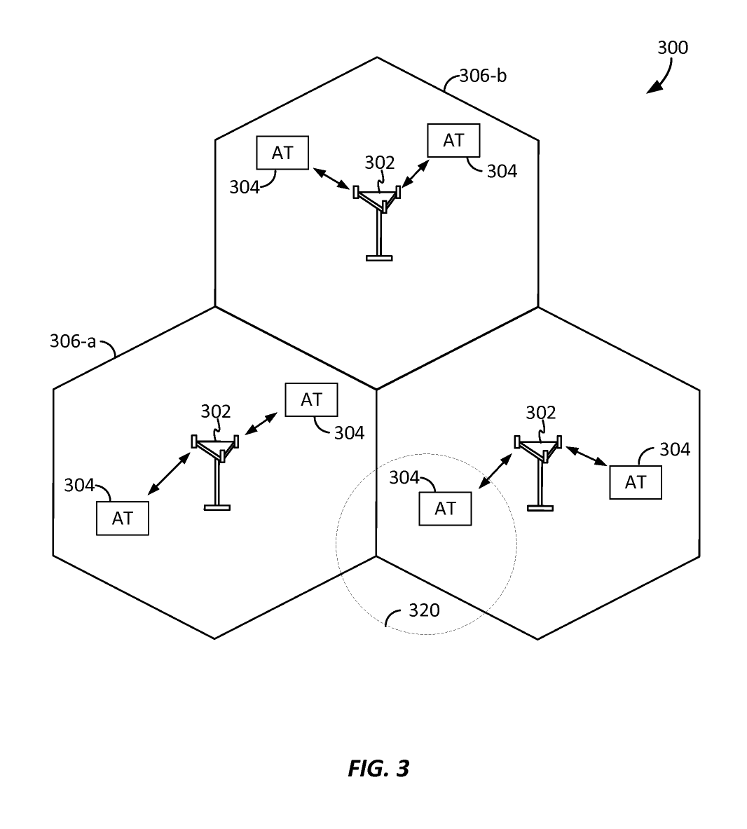

FIG. 3 is a block diagram of a network environment in which one or more aspects of the present disclosure may find application. The wireless communications system 300 is adapted to facilitate wireless communication between one or more base stations 302 and access terminals 304. The base stations 302 and access terminals 304 may be adapted to interact with one another through wireless signals. In some instances, the wireless interaction may occur on multiple carriers (waveform signals of different frequencies). Each modulated signal may carry control information (e.g., pilot signals), overhead information, data, etc.

The base stations 302 can wirelessly communicate with the access terminals 304 via a base station antenna. The base stations 302 may each be implemented generally as a device adapted to facilitate wireless connectivity (for one or more access terminals 304) to the wireless communications system 300. The base stations 302 are configured to communicate with the access terminals 304 under the control of a base station controller (not shown). Each of the base station 302 sites can provide communication coverage for a respective geographic area. The coverage area 306 for each base station 302 here is identified as cells 306-a, 306-b, or 306-c. The coverage area 306 for a base station 302 may be divided into sectors (not shown, but making up only a portion of the coverage area). The system 300 may include base stations 302 of different types (e.g., macro, micro, pico, and/or femtocell base stations).

One or more access terminals 304 may be dispersed throughout the coverage areas 306. Each access terminal 304 may communicate with one or more base stations 302 on one or more wireless channels. An access terminal 304 may generally include one or more devices that communicate with one or more other devices through wireless signals. Such an access terminal 304 may also be referred to by those skilled in the art as a user equipment (UE), a mobile station (MS), a subscriber station, a mobile unit, a subscriber unit, a wireless unit, a remote unit, a mobile device, a wireless device, a wireless communications device, a remote device, a mobile subscriber station, a mobile terminal, a wireless terminal, a remote terminal, a handset, a terminal, a user agent, a mobile client, a client, or some other suitable terminology. An access terminal 304 may be a mobile terminal and/or an at least substantially fixed terminal Examples of an access terminal 304 include a mobile phone, a computer, a smartphone, a pager, a wireless modem, a personal digital assistant, a personal information manager (PIM), a personal media player, a palmtop computer, a laptop computer, a tablet computer, a television, an appliance, an entertainment device, an e-reader, a digital video recorder (DVR), a machine-to-machine (M2M) device, and/or other communication/computing device which communicates, at least partially, through a wireless or cellular network.

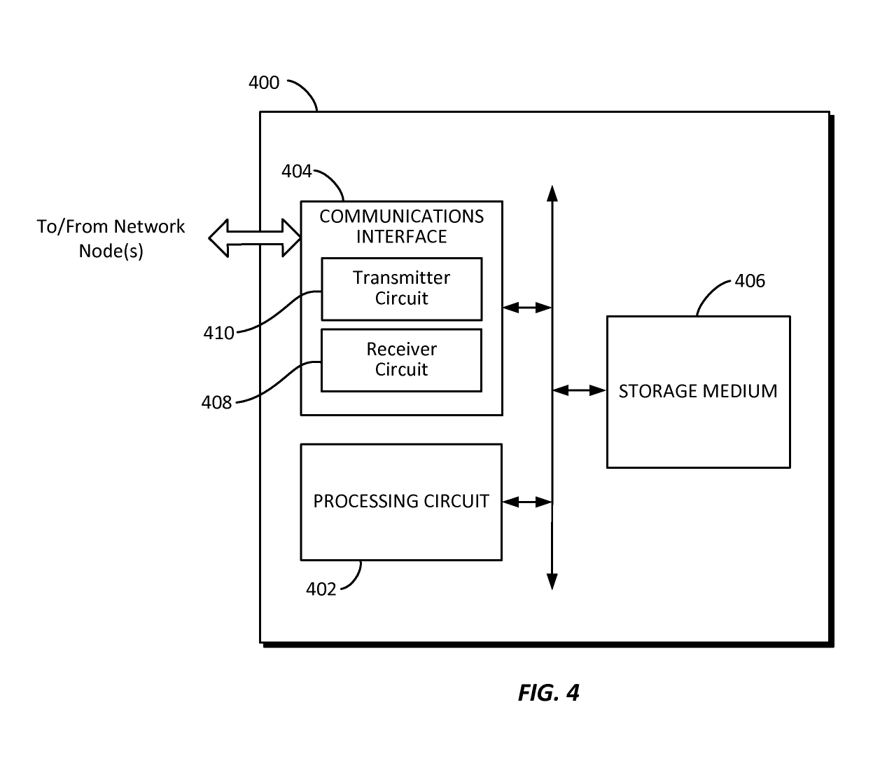

FIG. 4 is a conceptual block diagram illustrating some components of a wireless device 400 according to an aspect of the present disclosure. The wireless device 400 may be used as the access terminal 304. The wireless device 400 includes a processing circuit 402 coupled to or placed in electrical communication with a communications interface 404 and a storage medium 406.

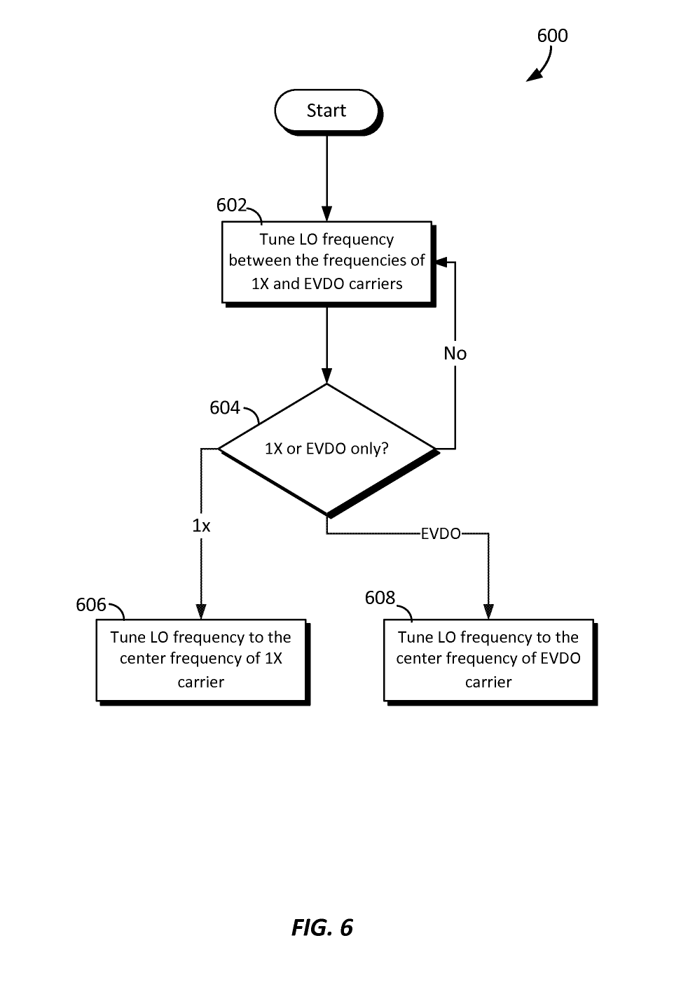

The processing circuit 402 is arranged to obtain, process and/or send data, control data access and storage, issue commands, and control other desired operations. The processing circuit 402 may include circuitry adapted to implement the various functions and processes described throughout this specification. The storage medium 406 may contain suitable programming or code to be executed by the processing circuit 402 to perform the various operations and processes described herein. For example, the processing circuit 402 may be implemented as one or more processors, one or more controllers, and/or other structure configured to execute executable programming. Examples of the processing circuit 402 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein, for example, the functionalities described in FIGS. 6-11. A general purpose processor may include a microprocessor, as well as any conventional processor, controller, microcontroller, or state machine. The processing circuit 402 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 402 are for illustration, and other suitable configurations within the scope of the present disclosure are also contemplated.

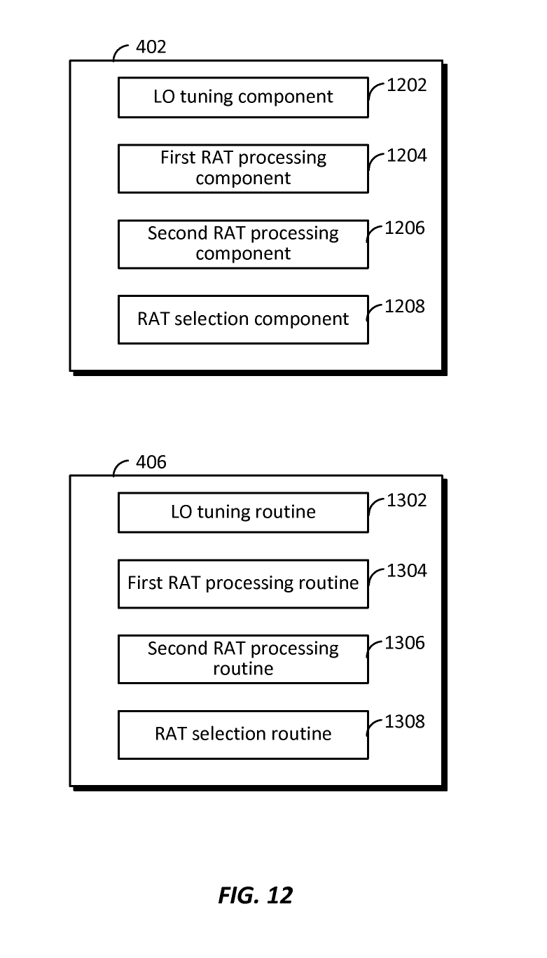

The processing circuit 402 is adapted for processing, including the execution of programming, which may be stored on the storage medium 406. As used herein, the term “programming” shall be construed broadly to include without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. In various aspects of the disclosure, the processing circuit 402 has a number of circuitries or components that may be configured, for example, by the programming stored on the storage medium 406 to perform the functionalities described in the flow charts of FIGS. 6, 7, 10, and 11. More detail of these circuitries, components, and programming will be described in FIG. 12, for example.

The communications interface 404 is configured to facilitate wireless communications of the wireless device 400. For example, the communications interface 404 may include circuitry and/or programming adapted to facilitate the communication of information bi-directionally with respect to one or more wireless network devices (e.g., network nodes). The communications interface 404 may be coupled to one or more antennas (not shown), and includes wireless transceiver circuitry, including at least one receiver circuit 408 (e.g., one or more receiver chains) and/or at least one transmitter circuit 410 (e.g., one or more transmitter chains). In some scenarios, the receiver and transmitter may be stand-alone components while in others, they may be a unitary component. In some scenarios, the interface can be implemented as a transceiver.

The storage medium 406 may represent one or more computer-readable, machine-readable, and/or processor-readable devices for storing programming, such as processor executable code or instructions (e.g., software, firmware), electronic data, databases, or other digital information. The storage medium 406 may also be used for storing data that is manipulated by the processing circuit 402 when executing programming. The storage medium 406 may be any available media that can be accessed by a general purpose or special purpose processor, including portable or fixed storage devices, optical storage devices, and various other mediums capable of storing, containing and/or carrying programming By way of example and not limitation, the storage medium 406 may include a computer-readable, machine-readable, and/or processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof.

The storage medium 406 may be operatively coupled to the processing circuit 402 such that the processing circuit 402 can read information from, and write information to, the storage medium 406. That is, the storage medium 406 can be coupled to the processing circuit 402 so that the storage medium 406 is at least accessible by the processing circuit 402, including examples where the storage medium 406 is integral to the processing circuit 402 and/or examples where the storage medium 406 is separate from the processing circuit 402 (e.g., resident in the wireless device 400, external to the wireless device 400, distributed across multiple entities).

Programming stored at the storage medium 406, when executed by the processing circuit 402, causes the processing circuit 402 to perform one or more of the various functions and/or process steps described herein. For example, the storage medium 406 may contain programming routines adapted to perform fast local oscillator (LO) tuning at the transmitter circuit 410 to mitigate the undesirable effects of RSB, as described herein. Thus, according to one or more aspects of the present disclosure, the processing circuit 402 is adapted to perform (in conjunction with the storage medium 406) any or all of the processes, functions, steps and/or routines for any or all of the wireless devices or access terminals described herein. As used herein, the term “adapted” in relation to the processing circuit 402 may refer to the processing circuit 402 being one or more of configured, employed, implemented, and/or programmed (in conjunction with the storage medium 406) to perform a particular process, function, step and/or routine according to various features described herein.

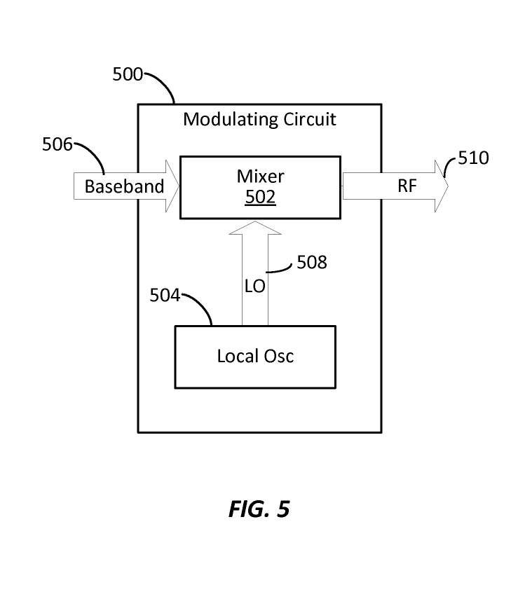

FIG. 5 is a conceptual block diagram illustrating select components of a modulating circuit 500 in accordance with an aspect of the disclosure. The modulating circuit 500 may be included in the transmitter circuit 410. The modulating circuit 500 includes a mixer 502 and a local oscillator circuit 504 that generates an LO signal 508. The mixer 502 receives a baseband signal 506 and the LO signal 508, which are combined to generate an output RF signal 510. In an aspect of the disclosure, the LO signal 508 may be a carrier frequency of an allocated wireless channel, and the baseband signal 506 can represent the data signal that modulates the LO signal 508 to carry the information to be transmitted. The frequency of the RF signal 510 may be set to the desired frequency by tuning the frequency of the local oscillator 504 to a suitable frequency. The RF signal 510 will have two components corresponding to the sum and difference between the frequencies of the baseband signal 506 and LO signal 508. An RSB signal (e.g., signal 14 of FIG. 1) will be at the frequency equal to the difference between the LO signal (e.g., a carrier signal) and the baseband signal (e.g., a modulating signal).

Referring back to FIG. 3, assume that a wireless device (e.g., an access terminal 304) is configured to transmit data utilizing dual reverse link EVDO carriers, as an example. Even in this case, the RSB issue (see FIGS. 1 and 2) is still not a significant problem. This is because both carriers follow the same path to the same base station, and thus have the same path loss. Since the RSB signal falls in the same channel (e.g., channel A in FIG. 2) as the intended signal, the receiver can generally handle any RSB interference/noise without significant issue. Even where the RSB signal falls on another channel, it is generally assumed that the channel on which the RSB signal falls is also used by the same base station. In this case, it is generally the same as above, where the power of the RSB signal is far lower than that of the user's intended signal using that channel.

In another aspect of the disclosure, the communications network 300 may be an LTE network, and the uplink transmission may utilize single-carrier FDMA (SC-FDMA). For each time instance, the uplink waveform occupies a part of a continuous chunk of spectrum, which is not necessarily centered at the frequency of the local oscillator (LO). The LO is generally centered at the allocated spectrum that the access terminal may utilize for uplink transmissions, and thus, the RSB signal generally falls within this allocated spectrum and does not cause a significant issue.

In each of the above examples, it is assumed that the wireless device (e.g., the wireless device 400) transmits using a single radio technology (e.g., 1×, EVDO, LTE, etc.) on the reverse link (uplink). However, many modern devices enable transmission utilizing two different radio technologies individually or simultaneously. For example, a wireless device 400 may be configured to transmit two signals, which are not at the same frequency, but are transmitted by sharing the same power amplifier, local oscillator (LO), mixer, etc. One example of such a device is a single-band simultaneous voice and EVDO data (SB-SVDO) device. In these devices, the LO typically is set to oscillate at the center of the 1× and EVDO carrier frequencies. When only one technology is transmitting, there may an RSB signal at the frequency the other technology would transmit on (i.e., the mirror image opposite the transmitted frequency, about the LO frequency). However, once again, as the RSB interfering signal is typically small, the issue is not significant as long as the power of the RSB signal does not get very high. Therefore, in conventional homogeneous networks, other than limiting the power of the RSB signal to be reasonably small, there is generally no special treatment with respect to RSB signals.

Typically, the RSB signal can be suppressed by careful hardware design, including using careful calibration processes when the wireless device is manufactured, to guarantee the RSB signal is below a certain level. However, this is a costly process. Furthermore, unlike the homogeneous networks described above, in a heterogeneous network where there are many femtocells or picocells (i.e., various forms of low-power base stations) in the system, the relatively low power RSB signal from one wireless device may create a relatively large interference for another communication link. That is, if there is a so-called “near-far” problem, caused by the difference in power from the nearby low-power cell and the farther-away high-power macro cell, the RSB signal can present issues to wireless devices in such scenarios.

As one example, an SB-SVDO wireless device (e.g., AT 304) may be communicating with a far-away base station (e.g., BS 302) utilizing 1× technology, but monitoring a nearby low-power base station (e.g., a pico cell 320 in FIG. 3) utilizing EVDO technology for page messages. In this case, the reverse link (uplink) for the 1× connection is active, but the reverse link for the EVDO network is not active. Here, the LO for the wireless device may be tuned between the frequencies of the 1× and EVDO reverse link carriers. The strong (relative to the low-power base station) 1× transmission signal from the wireless device in this case generates an RSB signal at the EVDO reverse link carrier frequency. Although the RSB signal is much weaker than the intended transmitting signal for the 1× network, because the wireless device is close to the EVDO base station, the RSB signal can still desense (i.e., cause interference with) the EVDO base station reception.

In another example, a heterogeneous LTE network may be implemented with closed association. In this case, two neighbor cells (eNBs) may be deployed with a closed association. Here, a closed association refers to a base station that is not publicly available, but it is using the operator's spectrum. For example, a femto base station can be configured only to serve a few selected users (e.g., the owner of the femto base station). In this case, even if a third party mobile phone is close to the femto base station, it cannot be served by it and has to access a macro base station potentially far away. Typically, this scenario will create interference problems. In an aspect of the disclosure, the eNBs may be any of the BS 302 of FIG. 3. As a first user (a first wireless device 304) moves closer to a second user's (a second wireless device 304) base station, and far from his own base station, the transmission to the first wireless device's own base station begins to need a higher power. In this case, an RSB signal of the first wireless device's transmission is generated at a mirror location. Although the RSB signal is far weaker than the signal intended for the first wireless device's base station because the first wireless device may be very near to the second wireless device's base station, the RSB signal can desense the second wireless device's reception of information from its own base station. In this case, because the second wireless device may transmit at a frequency that is near or at the mirror (RSB) location, the second wireless device may undesirably boost its transmitting power to compensate for the desense from the RSB signal generated by the first wireless device.

One or more aspects of the present disclosure provide a transmitter that can perform a fast local oscillator (LO) tuning such that the LO frequency will be retuned to be at or near the center of the spectrum allocated for the transmitted (TX) signal. The modulated TX signal and its RSB component will be within the intended wireless spectrum, and will not pose as interference for other communication links on other frequencies allocated to other channels. In an aspect of the disclosure, the wireless device 400 may be configured to perform fast LO retune to be described in more detail more.

FIG. 6 is a flow chart illustrating a process 600 operable at a dual radio access technology (dual RAT) wireless device for performing fast LO tuning in accordance with an aspect of the disclosure. The wireless device may be the wireless device 400 that is configured as a 1×/DO hybrid access terminal (which enables simultaneous voice communication utilizing the 1× network, and data communication utilizing the EVDO network), as described above. In step 602, the 1×/DO hybrid access terminal may initially set its LO frequency in between (e.g., at the middle) the 1× and the EVDO carrier frequencies. Therefore, the access terminal may simultaneously transmit on the 1× and EVDO frequencies. In step 604, if it is determined that the wireless device will only utilize the 1×RAT, the process 600 continues to step 606; otherwise, if it is determined that the wireless device will only utilize the EVDO RAT, the process continues to step 608.

When the wireless device is only using one RAT (e.g., 1× or EVDO), the LO frequency can be quickly retuned to be at or near the center of the frequency spectrum that is being utilized at any given time. In step 606, if only 1× is transmitting but EVDO is dormant, the LO may be tuned to or near the center frequency of the 1× carrier. On the other hand, in step 608, if only EVDO is transmitting but 1× is dormant, the LO may be tuned to or near the center frequency of the EVDO carrier. In this way, any RSB signal would generally be confined within the channel of the RAT being transmitted at any given time, reducing or avoiding RSB interference in the other technology. In this example, if both 1× and EVDO are transmitting simultaneously or concurrently again, the LO may be re-tuned to the frequency between (e.g., in the middle) the 1× and EVDO frequencies in step 602.

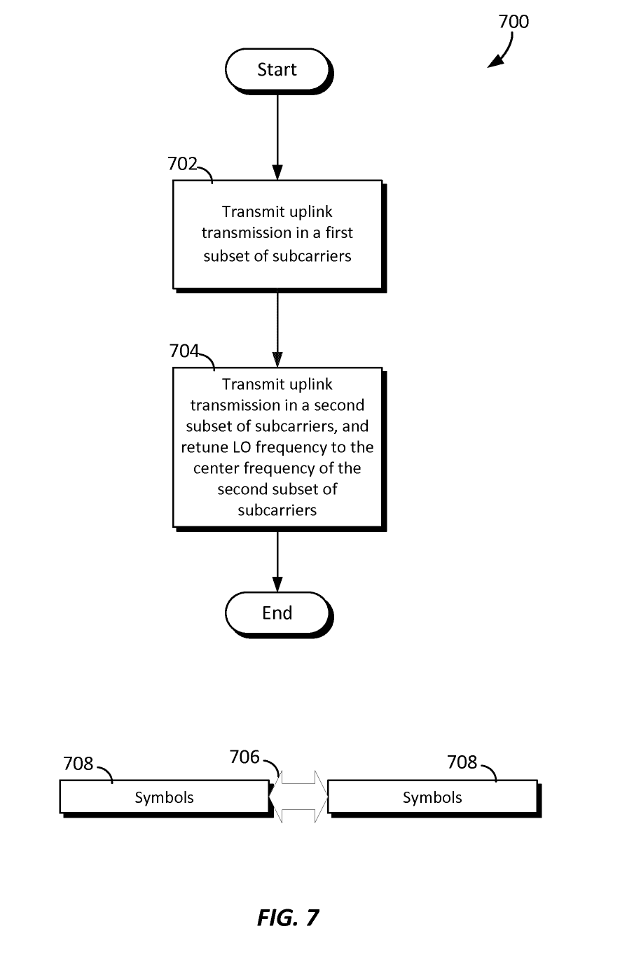

FIG. 7 is a flow chart illustrating a process 700 operable at an LTE wireless device for performing fast LO tuning in accordance with a further aspect of the disclosure. The LTE wireless device may be the wireless device 400 that is configured for wireless communication over an LTE network. The LO of the wireless device may be configured to tune to the center frequency of a subset of contiguous subcarriers being utilized by the wireless device at any given time for transmitting.

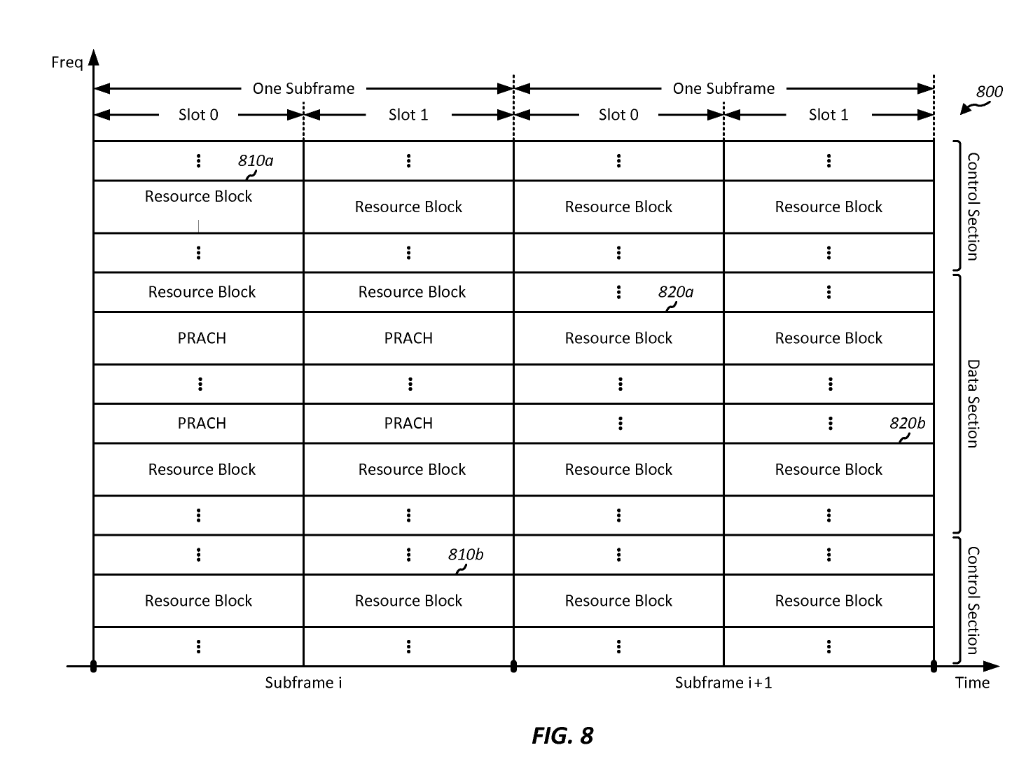

FIG. 8 is a diagram illustrating an example of an uplink (UL) frame structure 800 in LTE. The available resource blocks for the UL may be partitioned into a data section and a control section. The control section may be formed at the two edges of the system bandwidth and may have a configurable size. The resource blocks in the control section may be assigned for the transmission of control information. The data section may include all resource blocks not included in the control section. The design in FIG. 8 results in the data section including contiguous subcarriers, which may allow a single UE or wireless device to be assigned all of the contiguous subcarriers in the data section or a subset (e.g., one or more subcarriers) of the contiguous subcarriers. In some aspects of the disclosure, the subcarriers may be non-contiguous.

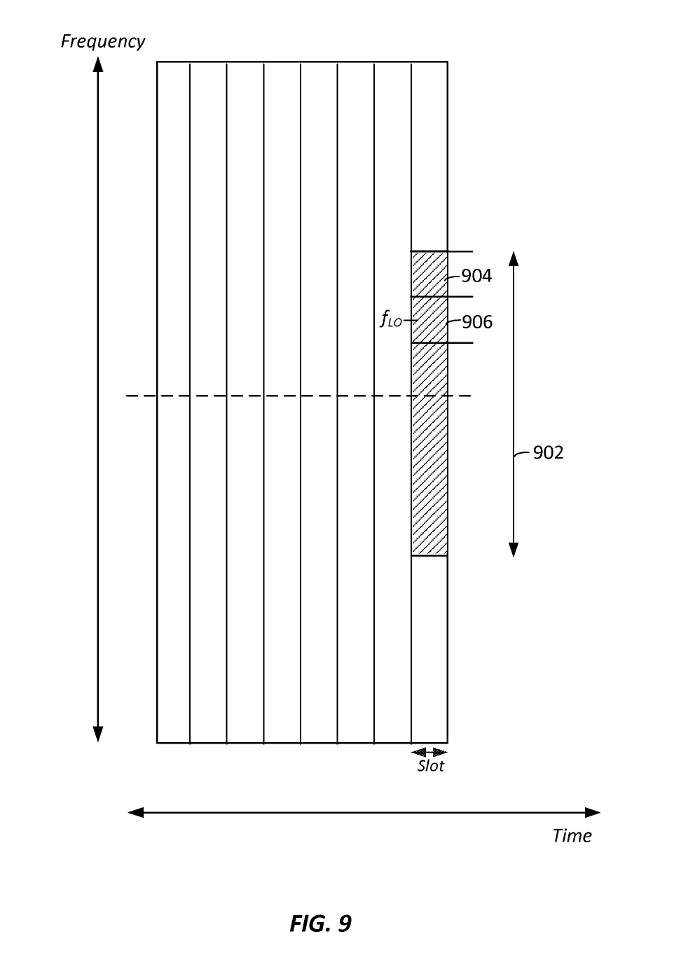

For example, the wireless device 400 (e.g., a UE) may be assigned resource blocks 810a, 810b in the control section to transmit control information to an eNB. The wireless device may also be assigned resource blocks 820a, 820b in the data section to transmit data to the eNB. The wireless device may transmit control information in a physical uplink control channel (PUCCH) on the assigned resource blocks in the control section. The wireless device may transmit only data or both data and control information in a physical uplink shared channel (PUSCH) on the assigned resource blocks in the data section. An UL transmission may span both slots of a subframe and may hop across frequency as shown in FIG. 9.

Referring to FIGS. 7 and 9, in step 702, the wireless device 400 may be transmitting an uplink transmission using any subset (e.g., one or more) of the contiguous subcarriers 902 (see FIG. 9) available for the uplink. Because of the nature of the SC-FDMA uplink utilized by the wireless device in an LTE network, the uplink transmission at any given time generally occupies only a small part of the available subcarriers 902 for the uplink. For example, the wireless device may be transmitting an uplink transmission in a first subset 904 of the subcarriers. Here, if the frequency of the LO is configured at the center of the entire contiguous subcarriers 902, the RSB signal may cause interference when the actual transmission is somewhat far from the LO frequency (i.e., center frequency of the subcarriers 902). Thus, in step 704 (see FIG. 7), when the wireless device hops to a different subset 906 (see FIG. 9) of the subcarriers to transmit an uplink transmission, the wireless device may re-tune its LO frequency to the center frequency f_{LO} of the subset 906 currently in use for the uplink transmission. Therefore, the RSB signal will stay within the same subset of subcarriers, and interference with other user's transmission may be reduced or avoided.

In an aspect of the disclosure, re-tuning of the LO may be implemented during the guard times 706 between transmitted symbols 708. In this way, any effect to the intended waveform, which may be caused by the re-tuning of the LO, can be reduced or avoided.

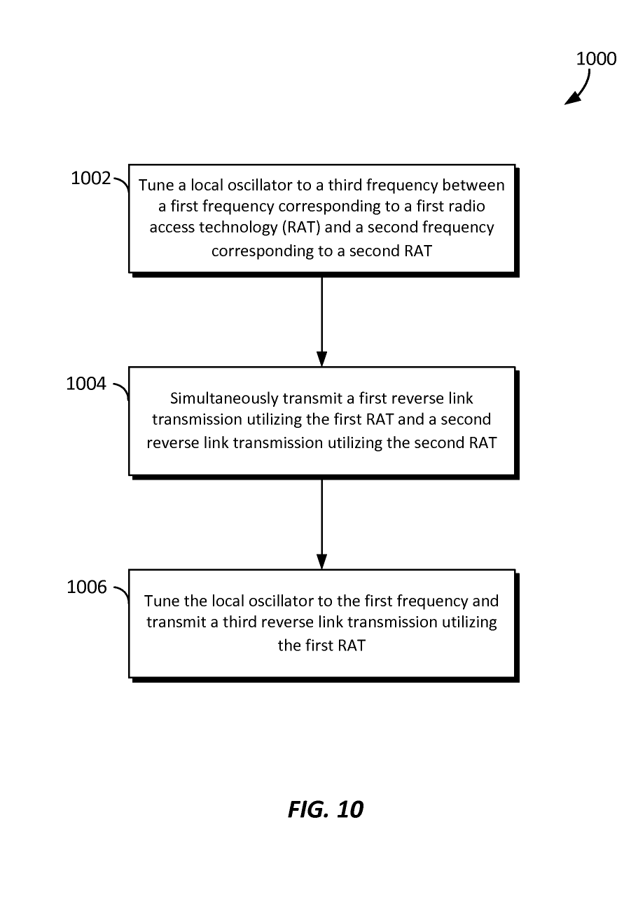

FIG. 10 is a flow chart illustrating a method 1000 of operating of a wireless device for simultaneous transmission utilizing two different RATs in accordance with an aspect of the disclosure. For example, the method 1000 may be operable at the wireless device 400. In step 1002, the wireless device tunes its local oscillator to a third frequency between a first frequency corresponding to a first RAT and a second frequency corresponding to a second RAT. In an aspect of the disclosure, the first RAT may be 1×, and the second RAT may be EVDO. In step 1004, the wireless device simultaneously transmits a first reverse link transmission utilizing the first RAT and a second reverse link transmission utilizing the second RAT. In step 1006, the wireless device tunes the local oscillator to the first frequency and transmits a third reverse link transmission utilizing the first RAT. Here, the wireless device is not transmitting on the second RAT. According to the method 1000, interference between the RSB signal caused by the first RAT transmission and other transmissions may be reduced or avoided.

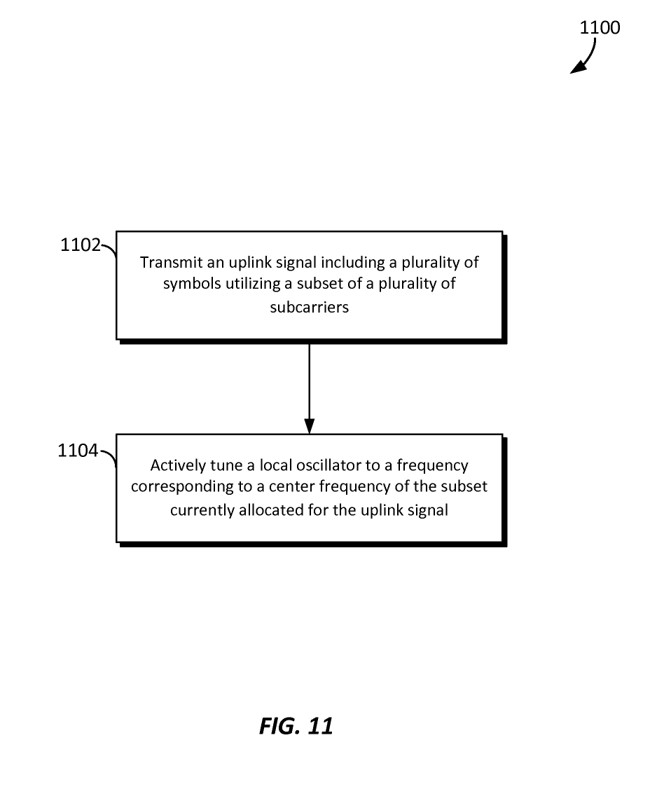

FIG. 11 is a flow chart illustrating a method 1100 operable at a wireless device configured for transmission utilizing an LTE network in accordance with an aspect of the disclosure. The wireless device may be the wireless device 400. In step 1102, the wireless device transmits an uplink signal comprising a plurality of symbols (e.g., symbols 708 of FIG. 7) utilizing a subset (e.g., subset 904) of subcarriers. In step 1104, the wireless device actively tunes a local oscillator to a frequency corresponding to a center frequency of the subset currently allocated for the uplink signal. In various aspects of the disclosure, the plurality of subcarriers may be contiguous or non-contiguous. In another aspect of the disclosure, the wireless device may tune the local oscillator during the guard times (e.g., FIG. 7, 706) between the transmitted symbols (e.g., symbols 708). In an aspect of the disclosure, the uplink signal may be an SC-FDMA uplink signal. According to the method 1100, interference between the RSB signal due to the uplink signal and transmissions on other subcarriers may be reduced or avoided.

While the above discussed aspects, arrangements, and embodiments are discussed with specific details and particularity, one or more of the components, steps, features and/or functions illustrated in the drawings may be rearranged and/or combined into a single component, step, feature or function or embodied in several components, steps, or functions. Additional elements, components, steps, and/or functions may also be added or not utilized without departing from the present disclosure. The apparatus, devices and/or components illustrated in the drawings may be configured to perform or employ one or more of the methods, features, parameters, and/or steps described in the drawings. The novel algorithms and processes described herein may also be efficiently implemented in software and/or embedded in hardware.

FIG. 12 is a functional block diagram of a processing circuit 402 and a storage medium 406 in accordance with an aspect of the disclosure. The processing circuit 402 may be configured to perform the various processes and functions described in reference to FIGS. 1-11 according to the programming stored at the storage medium 406. In an aspect of the disclosure, the processing circuit 402 may include an LO tuning component 1202, a first RAT processing component 1204, a second RAT processing component 1206, and a RAT selection component 1208. The storage medium 406 may include an LO tuning routine 1302, a first RAT processing routine 1304, a second RAT processing routine 1306, and a RAT selection routine 1308.

The LO tuning component 1202 and the LO tuning routine 1302 may provide the means for tuning the LO frequency of a transmitter circuit 410. The first RAT processing component 1204 and the first RAT processing routine 1304 may provide the means for performing various functions related to the first RAT (e.g., lx, LTE) described herein. The second RAT processing component 1206 and the second RAT processing routine 1306 may provide the means for performing various functions related to the second RAT (e.g., EVDO, LTE) described herein. In various aspects of the disclosure, the first RAT or second RAT may be other wireless technologies such as LTE, for example. In one aspect of the disclosure, the RAT selection component 1208 and the RAT selection routine 1308 may provide the means for performing various functions related to the selection of a first RAT or a second RAT as described in FIGS. 6 and 10. In another aspect of the disclosure, the LO tuning component 1202 and LO tuning routine 1302 may provide the means for performing the various functions and methods described in FIGS. 7-9 and 11.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associated with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

1. A method of wireless communication operable at a wireless device that is configured for simultaneous transmission utilizing different radio access technologies (RATs), comprising:
tuning a local oscillator to a tuning frequency between a first frequency corresponding to a first RAT and a second frequency corresponding to a second RAT;
simultaneously transmitting a first reverse link transmission utilizing the first RAT and a second reverse link transmission utilizing the second RAT; and
tuning the local oscillator to the first frequency and transmitting a third reverse link transmission utilizing the first RAT.

2. The method of claim 1, further comprising: tuning the local oscillator to the second frequency and transmitting a fourth reverse link transmission utilizing the second RAT.

3. The method of claim 1, wherein simultaneously transmitting a first reverse link transmission and a second reverse link transmission comprises transmitting the first reverse link transmission to a macro cell and transmitting the second reverse link transmission to a pico cell.

4. The method of claim 1, wherein the first RAT comprises 1× technology, and the second RAT comprises EVDO technology.

5. The method of claim 1, wherein the first frequency corresponds to a center frequency of a carrier of the first RAT, and the second frequency corresponds to a center frequency of a carrier of the second RAT.

6. An apparatus configured for simultaneous transmission utilizing different radio access technologies (RATs), comprising:
means for tuning a local oscillator of the apparatus to a tuning frequency between a first frequency corresponding to a first RAT and a second frequency corresponding to a second RAT;
means for simultaneously transmitting a first reverse link transmission utilizing the first RAT and a second reverse link transmission utilizing the second RAT; and
means for tuning the local oscillator to the first frequency and transmitting a third reverse link transmission utilizing the first RAT.

7. The apparatus of claim 6, further comprising: means for tuning the local oscillator to the second frequency and transmitting a fourth reverse link transmission utilizing the second RAT.

8. The apparatus of claim 6, wherein the means for simultaneously transmitting a first reverse link transmission and a second reverse link transmission comprises means for transmitting the first reverse link transmission to a macro cell and transmitting the second reverse link transmission to a pico cell.

9. The apparatus of claim 6, wherein the first RAT comprises 1× technology, and the second RAT comprises EVDO technology.

10. The apparatus of claim 6, wherein the first frequency corresponds to a center frequency of a carrier of the first RAT, and the second frequency corresponds to a center frequency of a carrier of the second RAT.

11. An apparatus configured for simultaneous transmission utilizing different radio access technologies (RATs), comprising:
a processor;
a communications interface operatively coupled to the processor; and
a memory operatively coupled to the processor;
wherein the processor and memory are configured to:
tune a local oscillator of the apparatus to a tuning frequency between a first frequency corresponding to a first RAT and a second frequency corresponding to a second RAT;
simultaneously transmit a first reverse link transmission utilizing the first RAT and a second reverse link transmission utilizing the second RAT; and
tune the local oscillator to the first frequency and transmit a third reverse link transmission utilizing the first RAT.

12. The apparatus of claim 11, wherein the processor and the memory are further configured to: tune the local oscillator to the second frequency and transmit a fourth reverse link transmission utilizing the second RAT.

13. The apparatus of claim 11, wherein for simultaneously transmitting a first reverse link transmission and a second reverse link transmission, the processor is further configured to transmit the first reverse link transmission to a macro cell and transmit the second reverse link transmission to a pico cell.

14. The apparatus of claim 11, wherein the first RAT comprises 1× technology, and the second RAT comprises EVDO technology.

15. The apparatus of claim 11, wherein the first frequency corresponds to a center frequency of a carrier of the first RAT, and the second frequency corresponds to a center frequency of a carrier of the second RAT.
